(19) United States
(12) Patent Application Publication
(10) Pub. No.: US 2020/0271210 A1
(43) Pub. Date: Aug. 27, 2020

(54) PLANET GEAR SUPPORT SHAFT, METHOD FOR MANUFACTURING PLANET GEAR SUPPORT SHAFT, AND PLANETARY GEAR UNIT

(71) Applicant: JTEKT CORPORATION, Osaka (JP)

(72) Inventors: Kotaro YAMASHITA, Kashiwara-shi (JP); Kazuyuki KOTANI, Toyota-shi (JP); Shoshi SUEMITSU, Anjo-shi (JP); Tomohiro HIROKAWA, Anjo-shi (JP); Makoto HAMANO, Anjo-shi (JP); Mitsushiko KATO, Anjo-shi (JP)

(73) Assignee: JTEKT CORPORATION, Osaka (JP)

(21) Appl. No.: 16/786,384

(22) Filed: Feb. 10, 2020

(30) Foreign Application Priority Data
Feb. 27, 2019 (JP) 2019-033707

(51) Int. Cl. F16H 57/00; F16H 57/08; F16H 57/04

(52) U.S. Cl. CPC F16H 57/0031; F16H 2057/085; F16H 57/0432; F16H 57/08

(57) ABSTRACT

A planet gear support shaft includes a cylindrical body that is open at both ends in a central axis direction. The cylindrical body has an inlet port through which lubricating oil is introduced into a hollow portion of the cylindrical body, and a discharge port through which the lubricating oil introduced into the hollow portion is discharged, the inlet port and the discharge port being open to an inner peripheral surface of the hollow portion at different positions in the central axis direction. An oil guide groove is provided between a first opening of the inlet port and a second opening of the discharge port in the inner peripheral surface. The oil guide groove is configured to guide the lubricating oil between the first opening and the second opening.

### CROSS-REFERENCE TO RELATED APPLICATION

This application claims priority to Japanese Patent Application No. 2019-033707 filed on Feb. 27, 2019, incorporated herein by reference in its entirety.

### BACKGROUND

### 1. Technical Field

The disclosure relates to planet gear support shafts that supports a planet gear, methods for manufacturing a planet gear support shaft, and planetary gear units.

### 2. Description of Related Art

There is a planetary gear unit that is used for, for example, shifting in a drive system of a vehicle (see, for example, Japanese Unexamined Patent Application Publication No. 2005-321026 (JP 2005-321026 A)). This planetary gear unit includes: an internal gear and an external gear (sun gear) that are supported such that the internal and external gears are coaxially rotatable relative to each other; a plurality of planet gears arranged between the internal gear and the external gear; a carrier that supports the planet gears such that the planet gears are rotatable and revolvable; and roller bearings that make rotation of the planet gears smooth.

The carrier of the planetary gear unit described in JP 2005-321026 has a pair of annular plates interposing the planet gears in the axial direction therebetween, and a plurality of support shafts inserted through the centers of the planet gears. The roller bearing having a plurality of needle rollers is disposed between the planet gear and the support shaft. The support shaft has both ends fitted in through holes formed in the pair of annular plates and is restrained from rotating. The support shaft is made of a cylindrical steel material and has a hollow hole drilled from a one axial end face of the support shaft. The hollow hole is a blind hole that does not extend through the support shaft. An opening at one end of the hollow hole is closed by a plug.

The plug is molded by drawing as follows. A flat sheet of a plug material is placed on the end face of the opening of the hollow hole of the support shaft and is press-fitted into the hollow hole with a punch so as to have a bottomed cylindrical shape. The support shaft has a lubricating oil supply inlet port and a lubricating oil supply outlet port. Lubricating oil is introduced into the hollow hole through the lubricating oil supply inlet port, and the lubricating oil introduced into the hollow hole is supplied to the roller bearing through the lubricating oil supply outlet port. One of the pair of annular plates has an oil groove in a side surface of the annular plate, and the oil groove communicates with the lubricating oil support inlet port. Lubricating oil is introduced from the oil groove into the hollow hole through the lubricating oil supply inlet port due to the centrifugal force generated by rotation of the carrier. The plug inhibits leakage of the lubricating oil introduced into the hollow hole.

### SUMMARY

When manufacturing this support shaft, a lot of material is wasted as the hollow hole is drilled. It is also difficult to reduce cost as the process of molding the plug by drawing is required. Moreover, in a method in which the hollow hole is drilled and the plug is press-fitted therein, metal powder tends to be produced during drilling. When such metal powder remains in the hollow hole, it affects smooth rotation of the planet gear. Accordingly, a process of sufficiently cleaning the hollow hole after attaching the plug may be required, and this cleaning process may also contribute to an increase in cost.

The disclosure provides a planet gear support shaft, a method for manufacturing the planet gear support shaft, and a planetary gear unit that achieve reduction in cost.

A first aspect of the disclosure provides a planet gear support shaft that is inserted through a shaft hole of a planet gear to support the planet gear. The planet gear is disposed between an internal gear and an external gear that are supported such that the internal gear and the external gear are coaxially rotatable relative to each other. The planet gear support shaft includes a cylindrical body that is open at both ends in a central axis direction. The cylindrical body has an inlet port through which lubricating oil is introduced into a hollow portion of the cylindrical body, and a discharge port through which the lubricating oil introduced into the hollow portion is discharged. The inlet port and the discharge port are open to an inner peripheral surface of the hollow portion at different positions in the central axis direction. An oil guide groove is provided between a first opening of the inlet port and a second opening of the discharge port in the inner peripheral surface. The oil guide groove is configured to guide the lubricating oil between the first opening and the second opening.

A second aspect of the disclosure provides a method for manufacturing a planet gear support shaft that is inserted through a shaft hole of a planet gear to support the planet gear, the planet gear being disposed between an internal gear and an external gear that are supported such that the internal gear and the external gear are coaxially rotatable relative to each other. The method includes: cutting a steel pipe to a predetermined length to obtain a cylindrical pipe; drilling an inlet port and a discharge port at different positions of the cylindrical pipe in a central axis direction such that the inlet port and the discharge port extend from an inner peripheral surface to an outer peripheral surface of the cylindrical pipe; and cutting an inner peripheral surface of the cylindrical pipe to form between a first opening of the inlet port and a second opening of the discharge port an oil guide groove that guides lubricating oil between the first opening and the second opening.

A third aspect of the disclosure provides a planetary gear unit. The planetary gear unit includes: an internal gear and an external gear that are supported such that the internal gear and the external gear are coaxially rotatable relative to each other; a planet gear disposed between the internal gear and the external gear; and a carrier that supports the planet gear such that the planet gear is rotatable and revolvable. The carrier includes a frame that is coaxially rotatable relative to the internal gear and the external gear, and the support shaft attached to the frame to support the planet gear.

The above configuration achieves reduction in cost for the planet gear support shaft and the planet gear unit.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is an exploded perspective view of a planet gear unit using planet gear support shafts according to a first embodiment;

FIG. 2A is a sectional view of a planet gear and a support shaft taken in an axial direction;

FIG. 2B is a sectional view taken along line IIB-IIB in FIG. 2A, namely taken in a direction perpendicular to the axial direction;

FIG. 3A is a sectional view of the support shaft taken along a central axis of the support shaft;

FIG. 3B is a sectional perspective view of the support shaft in the section of FIG. 3A;

FIGS. 4A to 4D are illustrations of a manufacturing process of the support shaft;

FIG. 5A is a sectional view of a support shaft according to a second embodiment taken along a central axis of the support shaft;

FIG. 5B is a sectional perspective view of the support shaft in the section of FIG. 5A;

FIG. 6A is a sectional view of a support shaft according to a third embodiment taken along a central axis of the support shaft;

FIG. 6B is a sectional perspective view of the support shaft in the section of FIG. 6A;

FIG. 7A is a sectional view of a support shaft according to a fourth embodiment taken along a central axis of the support shaft;

FIG. 7B is a sectional perspective view of the support shaft in the section of FIG. 7A;

FIG. 8A is a sectional view of a support shaft according to a fifth embodiment taken along a central axis of the support shaft; and

FIG. 8B is a sectional perspective view of the support shaft in the section of FIG. 8A.

### DETAILED DESCRIPTION OF EMBODIMENTS

### First Embodiment

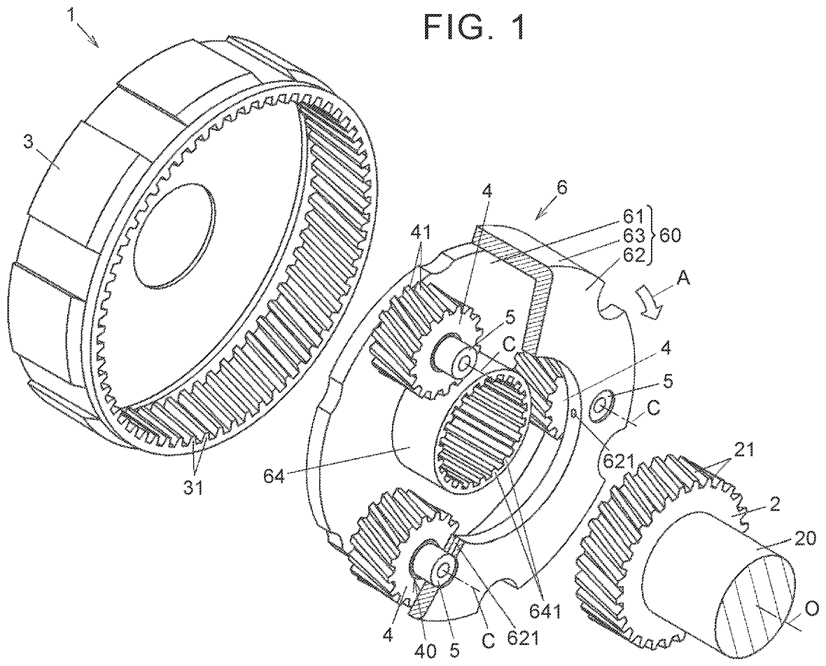

An embodiment of the disclosure will be described with reference to FIGS. 1 to 4D. The embodiments described below are intended to show specific examples that are suitable for carrying out the disclosure. Although various technical matters that are technically preferable are described specifically in some parts of the embodiments, the technical scope of the disclosure is not limited by the specific embodiments.

Overall Configuration of Planetary Gear Unit

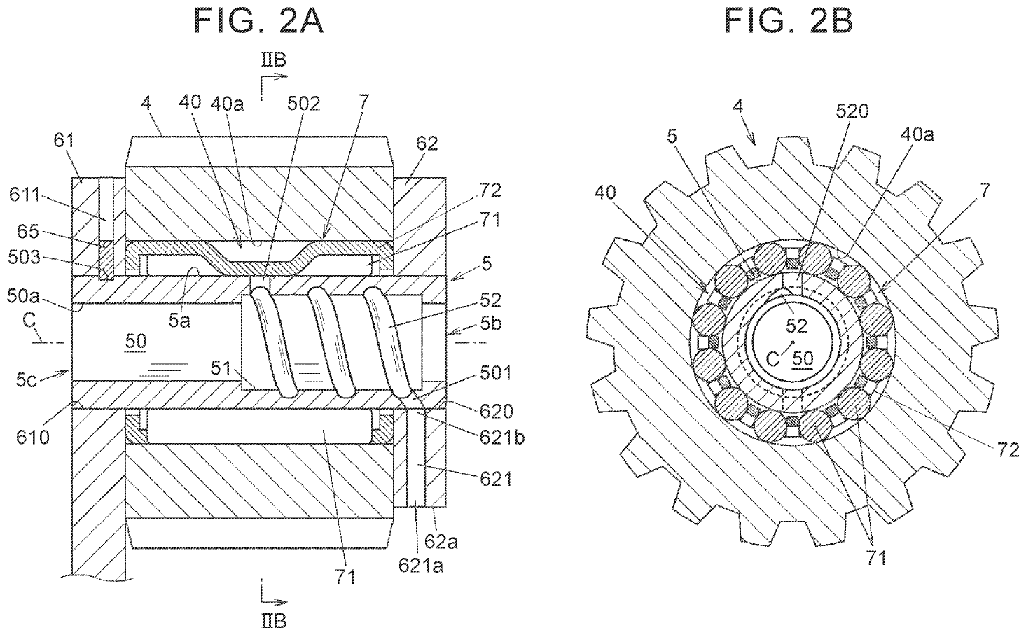

FIG. 1 is an exploded perspective view of a planetary gear unit using planet gear support shafts (hereinafter referred to as the “support shafts”) according to the present embodiment. FIGS. 2A and 2B illustrate a planet gear and the support shaft. FIG. 2A is a sectional view taken in the axial direction, and FIG. 2B is a sectional view taken along line IIB-IIB in FIG. 2A, namely taken in a direction perpendicular to the axial direction.

A planetary gear unit 1 includes an external gear 2, an internal gear 3, a plurality of (in the present embodiment, three) planet gears 4, a carrier 6, and roller bearings 7. The external gear 2 has external teeth 21 on an outer peripheral surface of the external gear 2. The internal gear 3 has internal teeth 31 on an inner peripheral surface of the internal gear 3. The planet gears 4 are arranged between the external gear 2 and the internal gear 3 and have external teeth 41 meshing with the external teeth 21 and the internal teeth 31. The carrier 6 includes a plurality of (three) support shafts 5 supporting the respective planet gears 4. Each of the roller bearings 7 is disposed between a corresponding one of the planet gears 4 and a corresponding one of the support shafts 5. The external gear 2, the internal gear 3, and the carrier 6 are supported such that the external gear 2, the internal gear 3, and the carrier 6 are coaxially rotatable relative to each other. The carrier 6 supports the planet gears 4 such that the planet gears 4 are rotatable and revolvable.

For example, the planetary gear unit 1 is used for a transmission for changing the speed of rotation of a rotary shaft (crankshaft) of an engine that is a driving source for an automobile. When one of the three elements of the planetary gear unit 1, namely one of the external gear 2, the internal gear 3, and the carrier 6, is held stationary and torque is input to another one of the three elements, the input torque is reduced or increased in speed and transmitted to the remaining one element. Sliding of each part of the planetary gear unit 1 is made smooth by lubricating oil (e.g., transmission oil). In FIG. 1, the rotation direction in the case where the carrier 6 is rotated is indicated by an arrow A.

The external gear 2 has a shaft 20 fixed in the center of the external gear 2 such that the external gear 2 and the shaft 20 are not rotatable relative to each other. The external gear 2 is disposed concentrically with the internal gear 3 and the carrier 6. Each planet gear 4 has a shaft hole 40 extending through the center of the planet gear 4 and has the support shaft 5 inserted through the shaft hole 40. Each planet gear 4 is thus supported by the support shaft 5 via the roller bearing 7. Each roller bearing 7 has a plurality of needle rollers 71 and a cage 72 holding the needle rollers 71. The needle rollers 71 roll on an inner peripheral surface 40a of the shaft hole 40 of the planet gear 4 and an outer peripheral surface 5a of the support shaft 5.

For example, when the internal gear 3 is held stationary and the shaft 20 is rotated, rotation of the external gear 2 that rotates with the shaft 20 is reduced in speed and output to an output shaft, not shown, that rotates with the carrier 6. At this time, the planet gears 4 revolve around the rotation axis O of the shaft 20, and each planet gear 4 rotates about a central axis C of the support shaft 5. A direction parallel to the central axis C is hereinafter referred to as a central axis direction.

Configuration of Carrier 6

the carrier 6 is comprised of a frame 60 and the plurality of (in the present embodiment, three) support shafts 5 attached to the frame 60. The frame 60 is coaxially rotatable relative to the external gear 2 and the internal gear 3 about the rotation axis O. The frame 60 includes a first annular plate 61, a second annular plate 62, a connection wall 63, and a fitting cylinder 64. The first and second annular plates 61, 62 are a pair of plates interposing the planet gears 4 in the axial direction therebetween. The connection wall 63 connects radial outer ends of the first and second annular plates 61, 62. The fitting cylinder 64 is fixed to a radial inner end of the first annular plate 61. The fitting cylinder 64 has a plurality of spline ridges 641 on an inner periphery of the fitting cylinder 64. For example, the output shaft is inserted through the fitting cylinder 64 and is spline-fitted therein.

Configuration of Support Shaft 5

Each support shaft 5 has a one axial end fitted in a fitting hole 610 provided in the first annular plate 61 and the other axial end fitted in a fitting hole 620 provided in the second annular plate 62. The support shaft 5 is a cylindrical body obtained by cutting a steel pipe to a predetermined length and is open at both ends in the central axis direction. The steel pipe is a material formed in a tubular shape in advance, and examples of the steel pipe include a seamless steel pipe produced by a rolling mill and a straight seam steel pipe produced by forming a plate material into a tubular shape by a tube mill.

the support shaft 5 has an inlet port 501 and a discharge port 502. Lubricating oil is introduced into a hollow portion 50 of the support shaft 5 through the inlet port 501, and the lubricating oil introduced into the hollow portion 50 is discharged from the hollow portion 50 through the discharge port 502. In the present embodiment, the support shaft 5 has a single inlet port 501 and a single discharge port 502. However, the support shaft 5 may have a plurality of inlet port 501 or a plurality of discharge ports 502. The inlet port 501 and the discharge port 502 are open to an inner peripheral surface 50a of the hollow portion 50 at different positions in the central axis direction. More specifically, the inlet port 501 is open to the inner peripheral surface 50a at a position near one end of the hollow portion 50 in the central axis direction, and the discharge port 502 is open to the inner peripheral surface 50a at a position near the center of the hollow portion 50 in the central axis direction.

The second annular plate 62 has an oil supply passage 621 communicating with the inlet port 501. One end 621a of the oil supply passage 621 is open to an inner peripheral surface 62a of the second annular plate 62, and the other end 621b thereof is open to the fitting hole 620. Lubricating oil having entered the oil supply passage 621 through the one end 621a flows due to the centrifugal force generated by rotation of the carrier 6 and thus flows into the inlet port 501 through the other end 621b. The inlet port 501 is open to the outer peripheral surface 5a of the support shaft 5 and the inner peripheral surface 50a of the hollow portion 50, and the lubricating oil having entered the inlet port 501 from the oil supply passage 621 is supplied to the hollow portion 50 through the inlet port 501. In the present embodiment, the inlet port 501 is tilted with respect to the radial direction of the support shaft 5 such that the inlet port 501 is open on the hollow portion 50 side at a position located closer to the center of the support shaft 5 in the central axial direction than a position at which the inlet port 501 is open on the oil supply passage 621 side.

The lubricating oil supplied to the hollow portion 50 flows in the hollow portion 50 and is discharged from the hollow portion 50 through the discharge port 502. The discharge port 502 is formed in the support shaft 5 at the outermost position in the radial direction of the frame 60 and is open to the inner peripheral surface 50a of the hollow portion 50 and the outer peripheral surface 5a of the support shaft 5. The lubricating oil discharged through the discharge port 502 is supplied to the roller bearing 7 and smoothens, for example, sliding between the needle rollers 71 and the cage 72.

The support shaft 5 further has a positioning fitting hole 503 at an end on the first annular plate 61 side. A positioning pin 65 is fitted in the positioning fitting hole 503. The positioning pin 65 is press-fitted in a pin hole 611 provided in the first annular plate 61, and the tip end of the positioning pin 65 is fitted in the positioning fitting hole 503. The positioning pin 65 restrains the support shaft 5 from rotating with respect to the frame 60 and positions the support shaft 5 in the axial direction.

The support shaft 5 is a cylindrical body that is open at both ends in the central axis direction as described above. Lubricating oil introduced into the hollow portion 50 through the inlet port 501 is therefore more likely to flow out through openings 5b, 5c at respective ends of the support shaft 5 in the central axis direction, as compared to a support shaft having an end closed by a plug as in the conventional example. Accordingly, in the present embodiment, first and second oil guide grooves 51, 52 are formed between the opening of the inlet port 501 and the opening of the discharge port 502 in the inner peripheral surface 50a of the hollow portion 50. The first and second oil guide grooves 51, 52 guide lubricating oil between the opening of the inlet port 501 and the opening of the discharge port 502. The first and second oil guide grooves 51, 52 will be described in detail below.

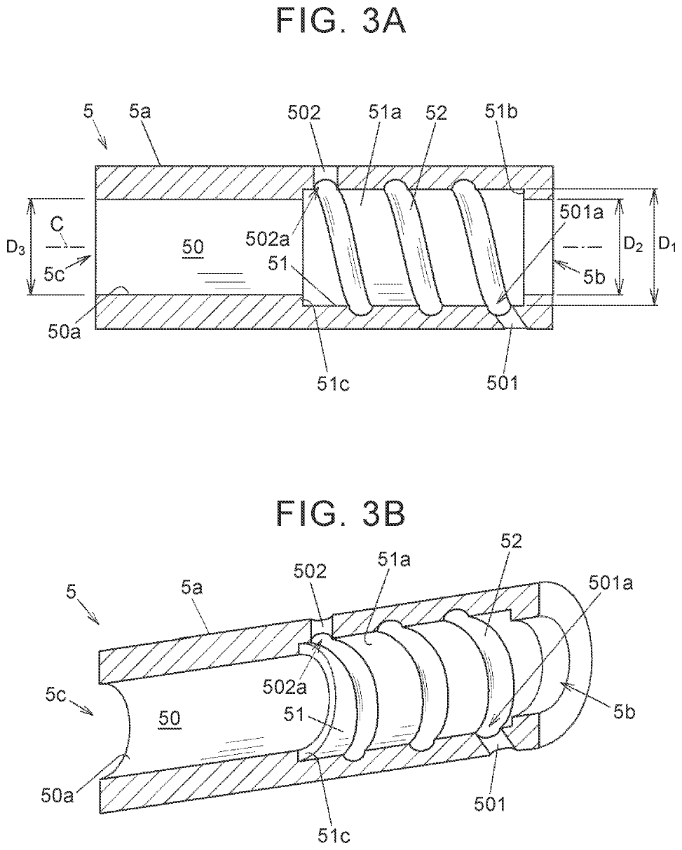

FIGS. 3A and 3B show the support shaft 5. FIG. 3A is a sectional view of the support shaft 5 taken along the central axis C, and FIG. 3B is a sectional perspective view of the support shaft 5 in the section of FIG. 3A. In FIGS. 3A and 3B, reference character 501a denotes the opening of the inlet port 501 in the inner peripheral surface 50a of the hollow portion 50, and reference character 502a denotes the opening of the discharge port 502 in the inner peripheral surface 50a of the hollow portion 50. The first and second oil guide grooves 51, 52 are formed between the openings 501a, 502a in the central axis direction.

The first oil guide groove 51 is formed in an annular shape of the inner peripheral surface 50a in the circumferential direction. An inside diameter D₁ of the first oil guide groove 51 is larger than a minimum inside diameter D₂ of a part of the hollow portion 50 located on one side (inlet port 501 side) in the central axis direction with respect to the first oil guide groove 51 and is larger than a minimum inside diameter D₃ of a part of the hollow portion 50 located on the other side in the central axis direction with respect to the first oil guide groove 51. In the present embodiment, since the support shaft 5 is produced by cutting a steel pipe to a predetermined length, the minimum inside diameters D₂, D₃ are equal to the inside diameter of the steel pipe.

At an end on the one side of the first oil guide groove 51 in the central axis direction, a stepped surface 51b is formed between an inner peripheral surface 51a of the first oil guide groove 51 and a part of the inner peripheral surface 50a of the hollow portion 50 in which the first oil guide groove 51 is not formed. At an end on the other side of the first oil guide groove 51 in the central axis direction, a stepped surface 51c is formed between the inner peripheral surface 51a of the first oil guide groove 51 and a part of the inner peripheral surface 50a of the hollow portion 50 in which the first oil guide groove 51 is not formed. These stepped surfaces 51b, 51c restrain lubricating oil introduced into the first oil guide groove 51 through the inlet port 501 from flowing out through the openings 5b, 5c at respective ends of the support shaft 5.

The second oil guide groove 52 is helically formed so as to extend in a tilted manner with respect to the central axis direction. In the present embodiment, the entire second oil guide groove 52 is formed in the inner peripheral surface 51a of the first oil guide groove 51. The second oil guide groove 52 has one end communicating with the opening 501a of the inlet port 501 and the other end communicating with the opening 502a of the discharge port 502. The second oil guide groove 52 extends in such a direction that, when the carrier 6 is rotated in the direction of arrow A (see FIG. 1), lubricating oil in the second oil guide groove 52 flows from the opening 501a of the inlet port 501 toward the opening 502a of the discharge port 502 due to the centrifugal force and gravity.

Method for Manufacturing Support Shaft 5

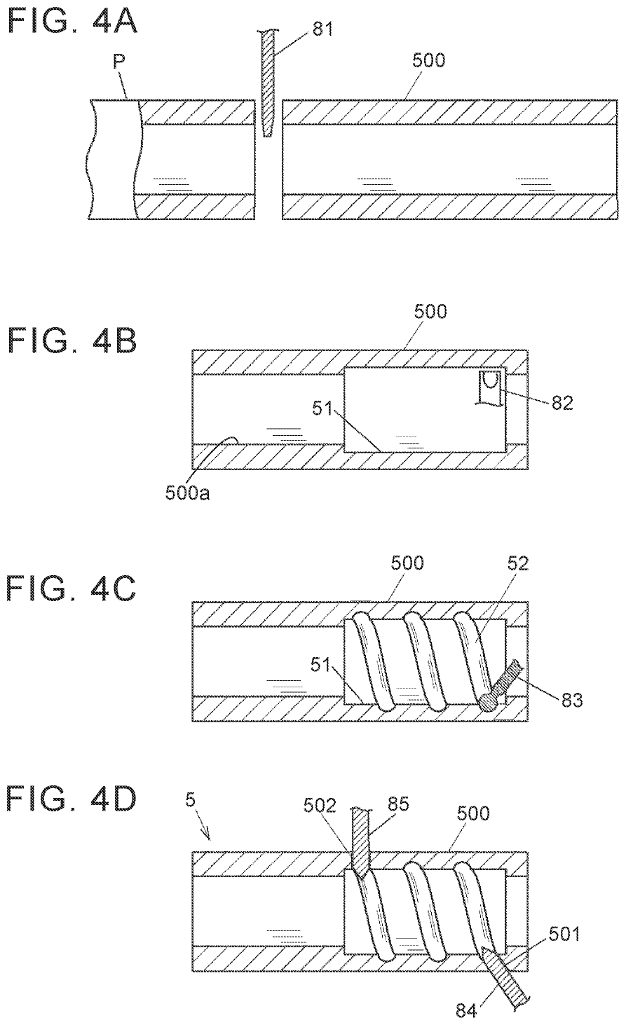

Next, a method for manufacturing the support shaft 5 will be described. The support shaft 5 is manufactured by a cutting process of cutting a steel pipe to a predetermined length to obtain a cylindrical pipe, a drilling process of drilling the inlet port 501 and the discharge port 502, and a cutting process of forming the first and second oil guide grooves 51, 52. Each process will be described in detail below with reference to FIGS. 4A to 4D.

FIG. 4A illustrates the cutting process. In the cutting process, a steel pipe (pipe P) is cut to a predetermined length using, for example, a circular saw 81 to obtain a short cylindrical pipe 500. The cylindrical pipe 500 has a cylindrical shape having inside diameter that is D₂ and D₃ shown in FIG. 3A and having inside and outside diameters that are constant along the entire length in a longitudinal direction.

FIG. 4B illustrates a first cutting process of cutting an inner peripheral surface 500a of the cylindrical pipe 500 obtained by the cutting process to form the first oil guide groove 51. The inner peripheral surface 500a is cut using a cutting tip 82 by a turning process. The inside diameter of a part of the cylindrical pipe 500 in the longitudinal direction is increased to D₁ shown in FIG. 3A by the first cutting process.

FIG. 4C illustrates a second cutting process of forming the helical second oil guide groove 52 in the inner peripheral surface 51a of the first oil guide groove 51 formed in the first cutting process. In the second cutting process, the second oil guide groove 52 is formed by using, for example, a ball end mill 83.

FIG. 4D illustrates the drilling process of forming the inlet port 501 and the discharge port 502 with drills 84, 85. The support shaft 5 is thus finished. The drilling process may be performed either before the first and second cutting processes or between the first and second cutting processes.

Functions and Effects of First Embodiment

According to the first embodiment described above, lubricating oil introduced into the hollow portion 50 through the inlet port 501 is guided to the discharge port 502 by the first and second oil guide grooves 51, 52, and the lubricating oil is restrained from flowing out through the openings 5b, 5c at respective ends of the support shaft 5 without closing both ends of the cylindrical pipe 500. Even if chips are produced in the first and second cutting process or the drilling process, the hollow portion 50 can be easily and reliably cleaned. Reduction in cost for the support shaft 5 and the planetary gear unit 1 is thus achieved.

### Second Embodiment

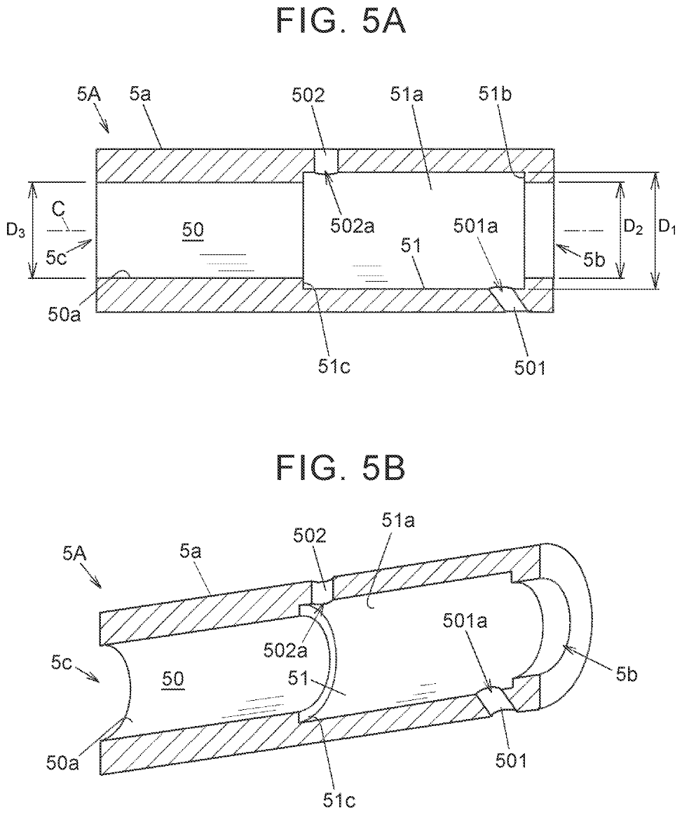

A second embodiment of the disclosure will be described with reference to FIGS. 5A and 5B. FIGS. 5A and 5B show a support shaft 5A according to the second embodiment. FIG. 5A is a sectional view of the support shaft 5A taken along the central axis C, and FIG. 5B is a sectional perspective view of the support shaft 5A in the section of FIG. 5A. In FIGS. 5A and 5B, components corresponding to those described in the first embodiment are denoted by the same reference characters, and description thereof will not be repeated.

The first embodiment is described with respect to the case where the annular first oil guide groove 51 extending in the circumferential direction and the helical second oil guide groove 52 are formed in the inner peripheral surface 50a of the hollow portion 50. However, the support shaft 5A according to the present embodiment only has the annular first oil guide groove 51.

This support shaft 5A also has functions and effects similar to those of the first embodiment. Moreover, since the second cutting process is not necessary in the second embodiment, further reduction in cost is achieved.

### Third Embodiment

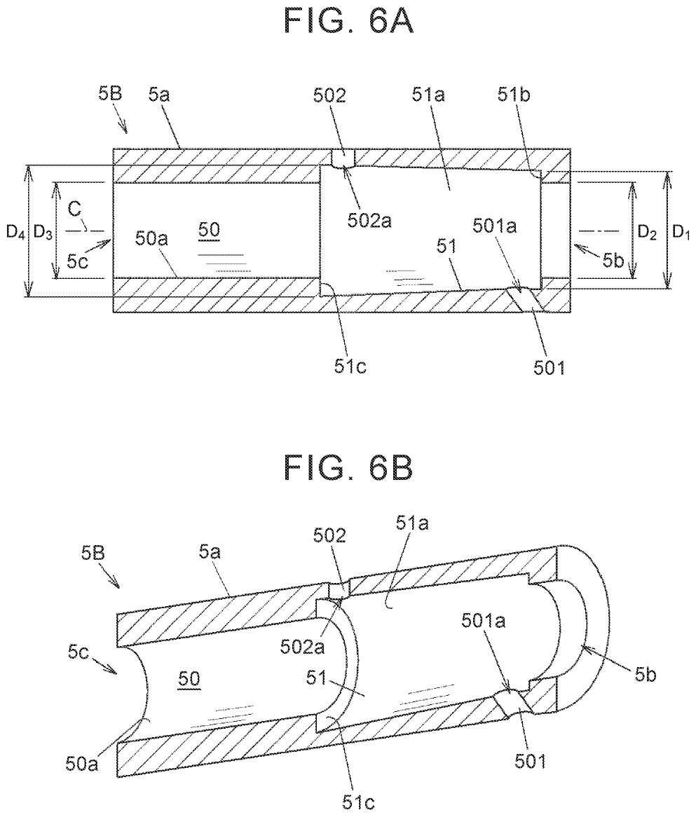

A third embodiment of the disclosure will be described with reference to FIGS. 6A and 6B. FIGS. 6A and 6B show a support shaft 5B according to the third embodiment. FIG. 6A is a sectional view of the support shaft 5B taken along the central axis C, and FIG. 6B is a sectional perspective view of the support shaft 5B in the section of FIG. 6A. In FIGS. 6A and 6B, components corresponding to those described in the first embodiment are denoted by the same reference characters, and description thereof will not be repeated.

The support shaft 5B according to the third embodiment is a modification of the support shaft 5A according to the second embodiment. The inner peripheral surface 51a, which is the bottom surface of the first oil guide groove 51, is tilted such that a radial distance from the inner peripheral surface 51a to the central axis C of the hollow portion 50 is larger on the opening 502a side than on the opening 501a side. That is, in the present embodiment, the first oil guide groove 51 has such a tapered shape that the inside diameter is larger on the discharge port 502 side than on the inlet port 501 side, and the inside diameter D₄ at the larger diameter end of the first oil guide groove 51 is larger than the inside diameter D₁ at the smaller diameter end of the first oil guide groove 51.

This support shaft 5B also has functions and effects similar to those of the first embodiment. Moreover, lubricating oil flows more easily toward the discharge port 502 due to the centrifugal force generated by revolution of the carrier 6, as compared to the case where the inner peripheral surface 51a of the first oil guide groove 51 is parallel to the central axis C. A larger amount of lubricating oil can thus be supplied to the roller bearing 7.

In the example illustrated in FIGS. 6A and 6B, the entire first oil guide groove 51 has a tapered shape. However, the support shaft 5B has the above effect, namely lubricating oil flows more easily toward the discharge port 502, as long as at least a part of the first oil guide groove 51 has a tapered shape. In other words, it is only necessary that at least a part of the inner peripheral surface 51a of the first oil guide groove 51 be tilted such that the radial distance from the inner peripheral surface 51a to the central axis C of the hollow portion 50 is larger on the opening 502a side than on the opening 501a side. The helical second oil guide groove 52 may be formed in the inner peripheral surface 51a of the tapered first oil guide groove 51.

### Fourth Embodiment

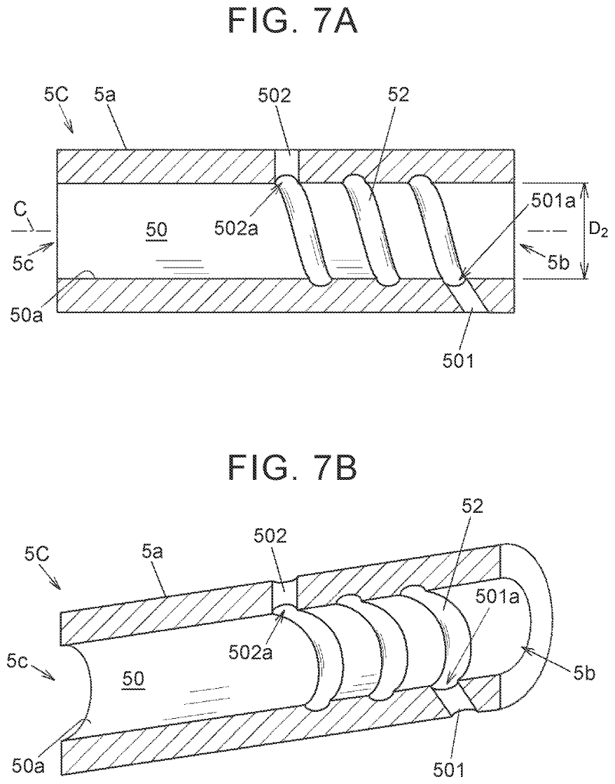

A fourth embodiment of the disclosure will be described with reference to FIGS. 7A and 7B. FIGS. 7A and 7B show a support shaft 5C according to the fourth embodiment. FIG. 7A is a sectional view of the support shaft 5C taken along the central axis C, and FIG. 7B is a sectional perspective view of the support shaft 5C in the section of FIG. 7A. In FIGS. 7A and 7B, components corresponding to those described in the first embodiment are denoted by the same reference characters, and description thereof will not be repeated.

The support shaft 5 of the first embodiment is described with respect to the case where the second oil guide groove 52 is formed in the inner peripheral surface 51a of the first oil guide groove 51. However, the support shaft 5C of the present embodiment does not have the first oil guide groove 51 and has the helical second oil guide groove 52 in the inner peripheral surface 50a of the hollow portion 50 that is the inner peripheral surface of a steel pipe as a material.

The support shaft 5C also has functions and effects similar to those of the first embodiment. Moreover, since the first cutting process is not necessary in the fourth embodiment, further reduction in cost is achieved.

### Fifth Embodiment

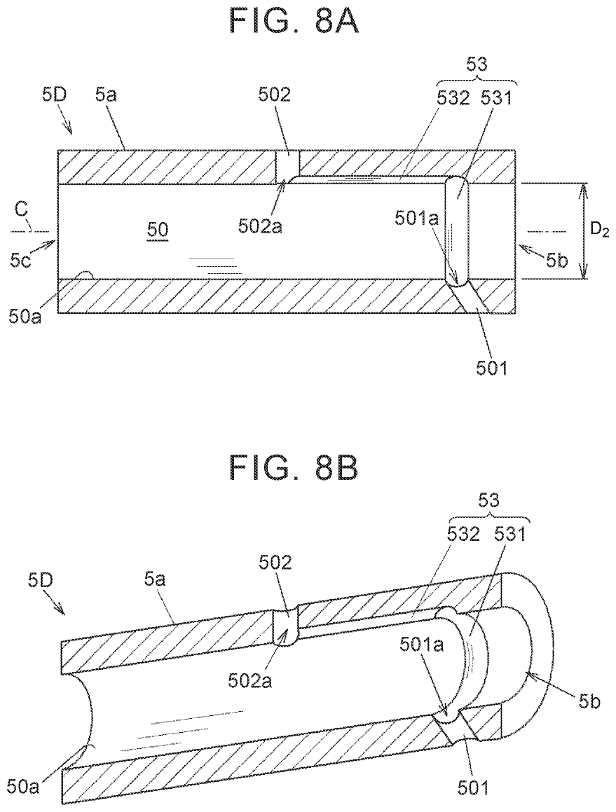

A fifth embodiment of the disclosure will be described with reference to FIGS. 8A and 8B. FIGS. 8A and 8B show a support shaft 5D according to the fifth embodiment. FIG. 8A is a sectional view of the support shaft 5D taken along the central axis C, and FIG. 8B is a sectional perspective view of the support shaft 5D in the section of FIG. 8A. In FIGS. 8A and 8B, components corresponding to those described in the first embodiment are denoted by the same reference characters, and description thereof will not be repeated.

The support shaft 5D has an oil guide groove 53 in the inner peripheral surface 50a of the hollow portion 50 that is the inner peripheral surface of a steel pipe as a material. The oil guide groove 53 has a circumferential groove 531 and an axial groove 532 that communicate with each other. The circumferential groove 531 extends in the circumferential direction of the inner peripheral surface 50a of the hollow portion 50 from the opening 501a of the inlet port 501. The axial groove 532 extends from the circumferential groove 531 toward the opening 502a of the discharge port 502. In the example illustrated in FIGS. 8A and 8B, the axial groove 532 is parallel to the central axis C, and the axial groove 532 and the circumferential groove 531 meet at right angles. However, the axial groove 532 may be tilted with respect to the central axis direction, and the circumferential groove 531 and the axial groove 532 may meet at an obtuse angle or an acute angle.

In the support shaft 5D, lubricating oil introduced through the inlet port 501 flows through the circumferential groove 531 toward the axial groove 532 and further flows through the axial groove 532 toward the discharge port 502 due to the centrifugal force or gravity. The support shaft 5D thus has functions and effects similar to those of the first embodiment. The oil guide groove 53 may be formed in the inner peripheral surface 51a of the first oil guide groove 51 according to the second or third embodiment.

Although the embodiments of the disclosure are described above, these embodiments are not intended to limit the disclosure according to the claims. It should be understood that not all of the combinations of the features described in the embodiments are essential to solve the problems of the disclosure. The disclosure can be modified as appropriate without departing from the spirit and scope of the disclosure.

What is claimed is:

1. A planet gear support shaft that is inserted through a shaft hole of a planet gear to support the planet gear, the planet gear being disposed between an internal gear and an external gear that are supported such that the internal gear and the external gear are coaxially rotatable relative to each other, the planet gear support shaft comprising
a cylindrical body that is open at both ends in a central axis direction, wherein:
the cylindrical body has an inlet port through which lubricating oil is introduced into
a hollow portion of the cylindrical body, and a discharge port through which the lubricating oil introduced into the hollow portion is discharged, the inlet port and the discharge port being open to an inner peripheral surface of the hollow portion at different positions in the central axis direction; and
an oil guide groove is provided between a first opening of the inlet port and a second opening of the discharge port in the inner peripheral surface, the oil guide groove being configured to guide the lubricating oil between the first opening and the second opening.

2. The planet gear support shaft according to claim 1, wherein:
the oil guide groove has an annular shape extending in a circumferential direction of the inner peripheral surface between the first opening and the second opening in the central axis direction; and
an inside diameter of the oil guide groove is larger than a minimum inside diameter of a part that is located on one side in the central axis direction with respect to the oil guide groove and is larger than a minimum inside diameter of a part that is located on the other side in the central axis direction with respect to the oil guide groove.

3. The planet gear support shaft according to claim 1, wherein at least a part of a bottom surface of the oil guide groove is tilted such that a radial distance from the bottom surface to a central axis of the hollow portion is larger on a second opening side than on a first opening side.

4. The planet gear support shaft according to claim 1, wherein the oil guide groove is a helical groove tilted with respect to the central axis direction.

5. The planet gear support shaft according to claim 1, wherein the oil guide groove has a circumferential groove and an axial groove that communicate with each other, the circumferential groove extending in a circumferential direction of the inner peripheral surface from the first opening, and the axial groove extending from the circumferential groove toward the second opening.

6. A method for manufacturing a planet gear support shaft that is inserted through a shaft hole of a planet gear to support the planet gear, the planet gear being disposed between an internal gear and an external gear that are supported such that the internal gear and the external gear are coaxially rotatable relative to each other, the method comprising:
cutting a steel pipe to a predetermined length to obtain a cylindrical pipe;
drilling an inlet port and a discharge port at different positions of the cylindrical pipe in a central axis direction such that the inlet port and the discharge port extend from an inner peripheral surface to an outer peripheral surface of the cylindrical pipe; and
cutting the inner peripheral surface of the cylindrical pipe to form between a first opening of the inlet port and a second opening of the discharge port an oil guide groove that guides lubricating oil between the first opening and the second opening.

7. A planetary gear unit, comprising:
an internal gear and an external gear that are supported such that the internal gear and the external gear are coaxially rotatable relative to each other;
a planet gear disposed between the internal gear and the external gear;
a carrier that supports the planet gear such that the planet gear is rotatable and revolvable, wherein
the carrier includes a frame that is coaxially rotatable relative to the internal gear and the external gear, and a support shaft attached to the frame and configured to support the planet gear,
the planet gear support shaft includes a cylindrical body that is open at both ends in a central axis direction,
the cylindrical body has an inlet port through which lubricating oil is introduced into a hollow portion of the cylindrical body, and a discharge port through which the lubricating oil introduced into the hollow portion is discharged, the inlet port and the discharge port being open to an inner peripheral surface of the hollow portion at different positions in the central axis direction, and
an oil guide groove is provided between a first opening of the inlet port and a second opening of the discharge port in the inner peripheral surface, the oil guide groove being configured to guide the lubricating oil between the first opening and the second opening.
